(19) United States
(12) Patent Application Publication
(10) Pub. No.: US 2026/0211182 A1
(43) Pub. Date: Jul. 23, 2026

(54) OPTICAL DEVICES AND METHODS OF MANUFACTURE

(71) Applicant: Taiwan Semiconductor Manufacturing Co., Ltd., Hsinchu (TW)

(72) Inventors: Chia-Han Tsou, Hsinchu (TW); Ming-Fa Chen, Taichung City (TW)

(21) Appl. No.: 19/217,692

(22) Filed: May 23, 2025

Related U.S. Application Data
(60) Provisional application No. 63/748,573, filed on Jan. 23, 2025.

(51) Int. Cl. G02B 6/13

(52) U.S. Cl. CPC G02B 6/13

(57) ABSTRACT

A method of forming an optical device as well as the optical device itself are described herein in which an interposer substrate is formed with optical devices in order to connect devices both electrically and optically. As such, both electrical signals and optical signals may be transmitted between a first optical device bonded to the interposer substrate and a second optical device bonded to the interposer substrate.

### PRIORITY CLAIM AND CROSS-REFERENCE

This application claims the benefit of U.S. Provisional Application No. 63/748,573, filed on Jan. 23, 2025, which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

An optical device can provide for the coupling of optical signals from an optical fiber to an optical waveguide for use in optical signaling and processing systems. The efficiency of optical coupling has gradually improved, making the design of tapers relevant to advancing optical signal transmission. However, improvements are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIG. 10 illustrates an interposer substrate, in accordance with some embodiments.

FIG. 11 illustrates bonding of the first optical package to the interposer substrate, in accordance with some embodiments.

FIG. 12A illustrates an encapsulation, in accordance with some embodiments.

FIG. 12B illustrates an overview of transmission and receiving optical signals, in accordance with some embodiments.

FIG. 13 illustrates a bonding film with optical components, in accordance with some embodiments.

FIG. 14 illustrates an interposer substrate with optical devices formed therein, in accordance with some embodiments.

FIG. 15 illustrates the first optical package being bonded with a dielectric-to-dielectric and metal-to-metal bond, in accordance with some embodiments.

FIG. 16 illustrates the first optical package being bonded with a dielectric-to-dielectric and metal-to-metal bond along with the bonding film with optical components, in accordance with some embodiments.

FIG. 17 illustrates a simplified version of optical interconnections, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be illustrated and discussed in which an interposer substrate is utilized to connect optical and electrical devices using both optical pathways as well as electrical pathways. However, the embodiments presented herein are intended to be illustrative and are not intended to limit the embodiments to the precise descriptions as discussed. Rather, the embodiments discussed may be incorporated into a wide variety of implementations, and all such implementations are fully intended to be included within the scope of the embodiments.

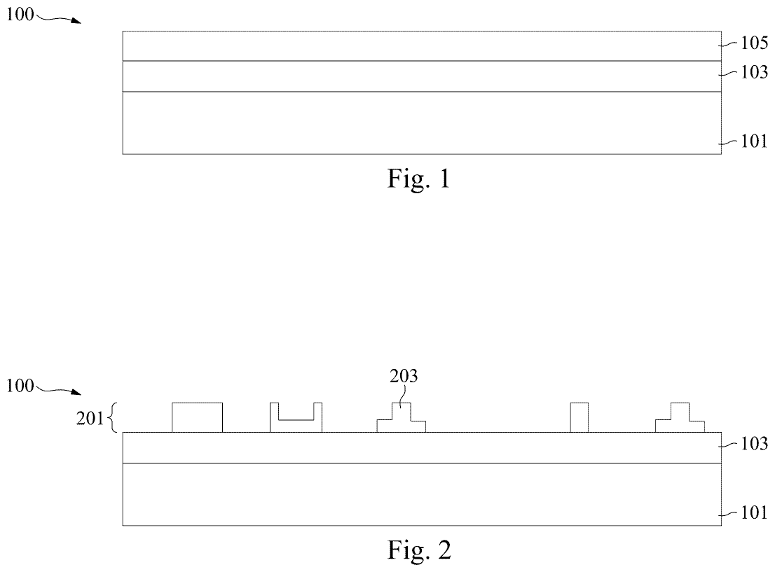

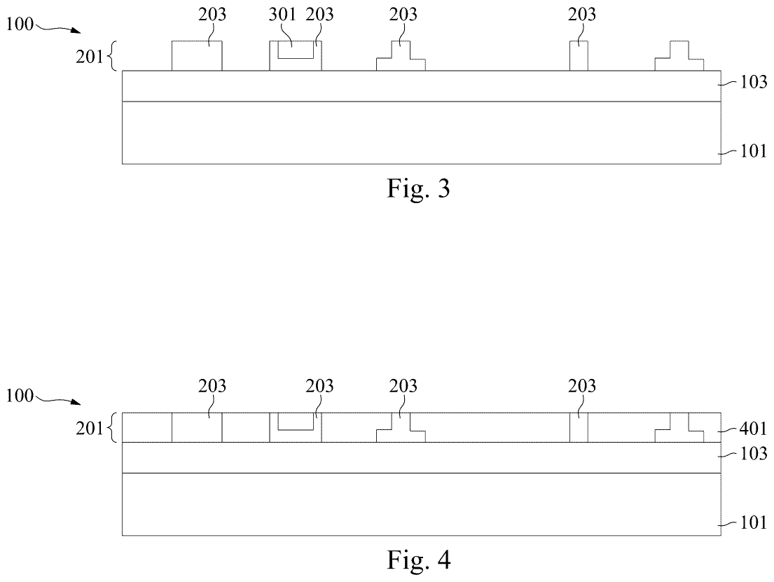

With reference now to FIG. 1, there is illustrated an initial structure of an optical interposer 100. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of the first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment, the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., edge couplers, grating couplers, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of the first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, the patterning process may be all or at least most of the manufacturing that is used to form these first optical components 203.

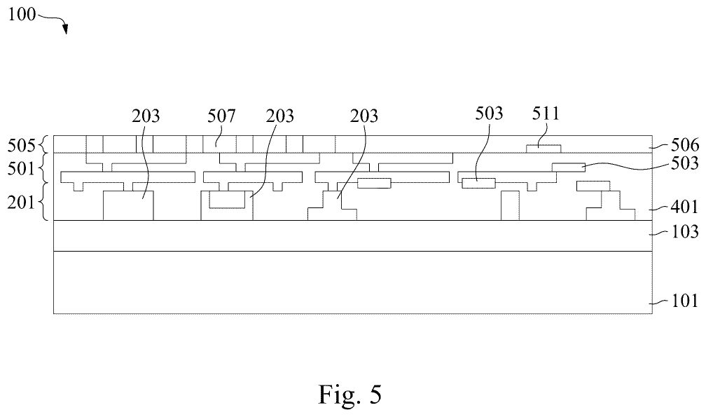

FIG. 3 illustrates that, for those components that utilize further manufacturing processes, such as Mach-Zehnder silicon-photonic switches that utilize resistive heating elements, additional processing may be performed either before or after the patterning of the material for the first active layer 201 for forming the first optical components 203. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

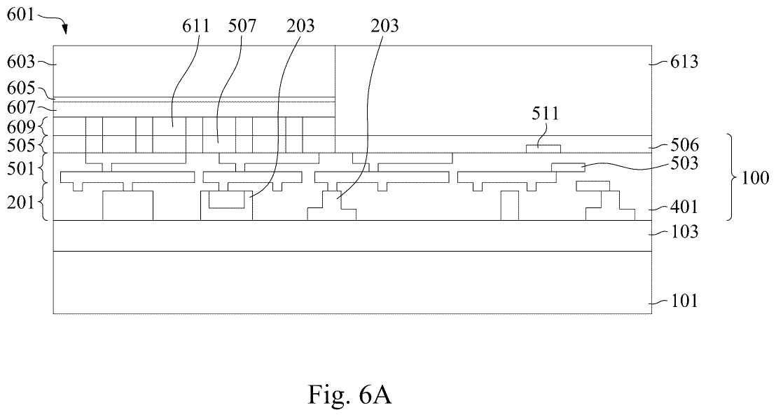

FIG. 4 illustrates that, once the first optical components 203 have been formed, a second insulator layer 401 may be deposited to cover the first optical components 203. The second insulator layer 401 may provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

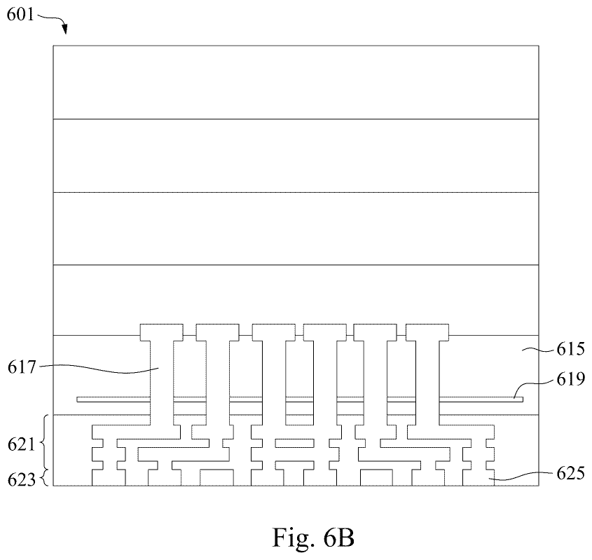

FIG. 5 illustrates that, once the first optical components 203 have been manufactured and the second insulator layer 401 has been formed, one or more second optical components 503 may be formed as part of first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide (e.g., glass), combinations of these, or the like, a semiconductor material such as silicon, or a polymer material deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

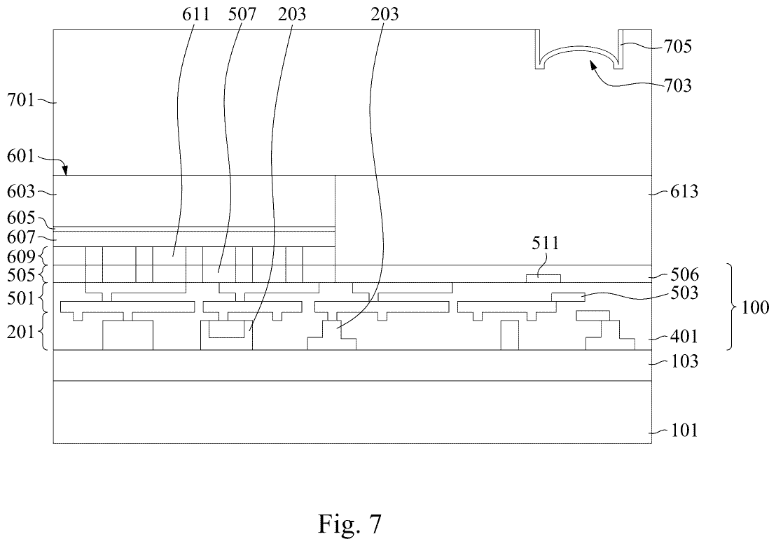

A first metallization layer 501 is formed over and around the one or more second optical components 503. In an embodiment the first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6A). In an embodiment the first metallization layers 501 are formed of alternating layers of dielectric (deposited to cover the one or more second optical components 503) and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Once the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 506 such as silicon oxide, silicon nitride, or the like. The first dielectric material 506 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 506 has been formed, first openings in the first dielectric material 506 are formed to expose conductive portions of the underlying layers in preparation to form first bond pads 507 within the first bonding layer 505. Once the first openings have been formed within the first dielectric material 506, the first openings may be filled with a seed layer and a plate metal to form the first bond pads 507 within the first dielectric material 506. The seed layer may be blanket deposited over top surfaces of the first dielectric material 506 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 506 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 506, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6A illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

FIG. 6B illustrates the particular embodiment in which the first semiconductor device 601 is the high bandwidth memory module. In this embodiment, the first semiconductor device 601 includes multiple semiconductor substrates 615 interconnected by second through-substrate vias (TSVs) 617, dielectric-to-dielectric and metal-to-metal bonds, or microbumps. FIG. 6A illustrates such structures for the bottom die within the module but not separately illustrating such structures for the other dies for clarity. Each of the semiconductor substrates 615 may (or may not) have a layer of active devices 619 and an overlying interconnect structure 621, a second bond layer 623 (similar to the first bond layer 505), and associated second bond pads 625 (similar to the first bond pads 507).

In an embodiment the first semiconductor device 601 and the first bonding layer 505 may be bonded using a dielectric-to-dielectric and metal-to-metal bonding process or microbumps. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the first semiconductor device 601. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 form a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6A additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

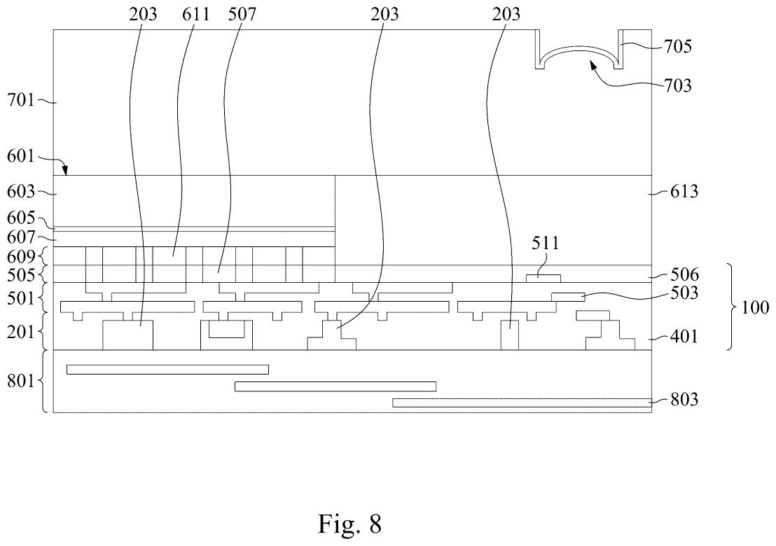

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

FIG. 7 additionally illustrates that the first support substrate 701 comprises a first coupling lens 703 positioned to facilitate movement from an optical fiber (not illustrated in FIG. 7). In an embodiment the first coupling lens 703 may be formed by shaping the material of the support substrate (e.g., silicon) using masking and etching processes. However, any suitable process may be utilized.

Additionally, if desired, a first anti-reflective coating (ARC) 705 may be formed on the first coupling lens 703. In an embodiment the first ARC 705 may be one or more layers of materials which help to prevent undesired reflections as light is focused through the first coupling lens 703. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC 705 may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

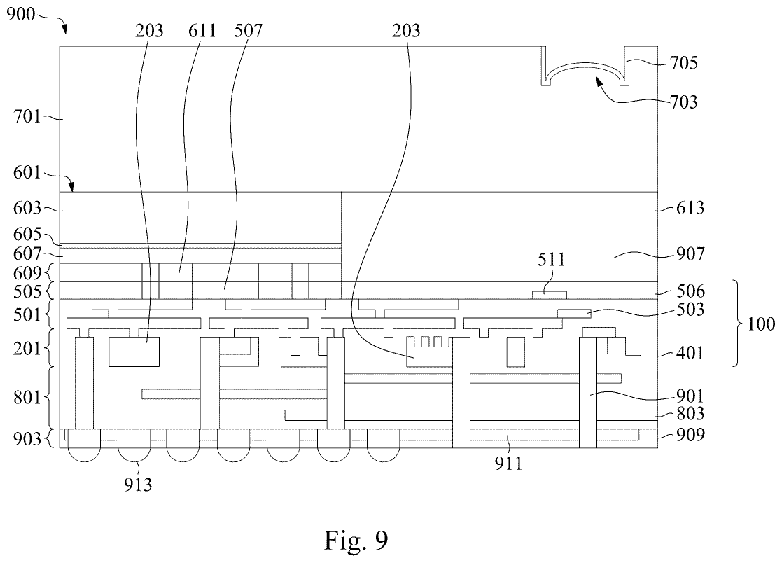

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

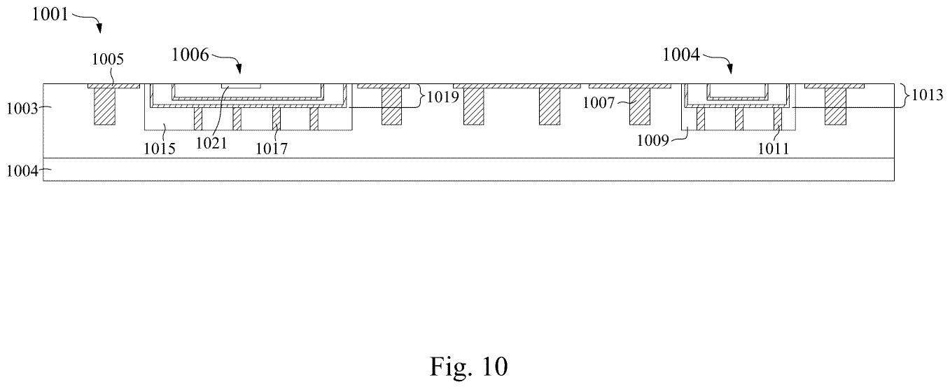

FIG. 9 illustrates formation of first through device vias (TDVs) 901 and formation of a third bonding layer 903 to form a first optical package 900 which, in some embodiments is an optical engine. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

Optionally, first external connectors 913 may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

However, because optical signals will be transmitted out of the first optical package 900, the first external connectors 913 may be located only along a portion of the first optical package 900. In particular, in those regions that are designed to transmit and receive optical signals from that side of the first optical package 900, the first external connectors 913 are removed so that they will not interfere with the transmission of the optical signals. As such, this region remains free from materials that obstruct the transmission of the optical signals.

Of course, while the use of first external connectors 913 is one embodiment which may be used in order to provide connections for the first optical package 900, this is intended to be illustrative and is not intended to limit the embodiments. Rather, any suitable method of physically, electrically, and in some cases optically connecting the first optical package 900, such as dielectric-to-dielectric and metal-to-metal bonding, may also be utilized. Any suitable method of bonding the first optical package 900 may be used.

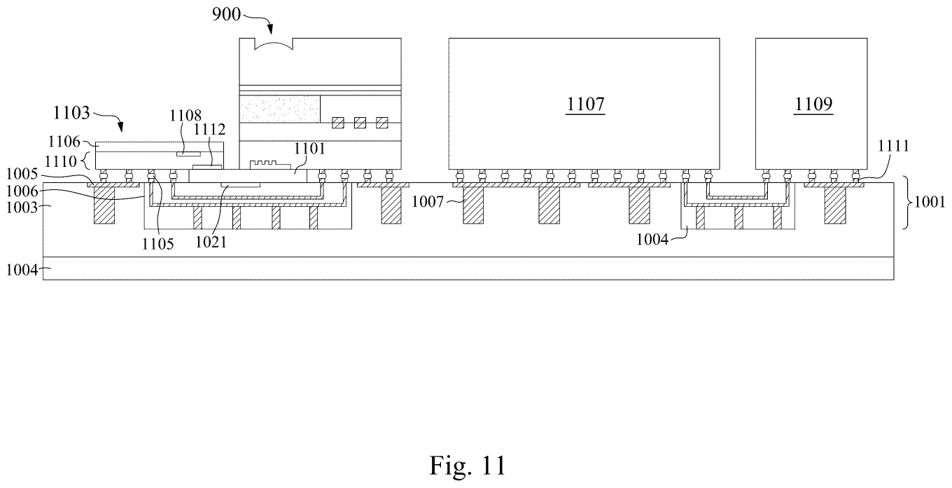

FIG. 10 illustrates an interposer substrate 1001 that is used to both electrically couple and also to optical couple the first optical package 900 with other devices to form, for example, a chip-on-wafer-on-substrate device. In an embodiment the interposer substrate 1001 comprises a semiconductor substrate 1003 (on, e.g., a support substrate 1004), third metallization layers 1005, and second through device vias (TDVs) 1007. The semiconductor substrate 1003 may comprise bulk silicon, doped or undoped, glass, ceramic materials, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate 1003. The first active devices comprise a wide variety of active devices and passive devices such as capacitors, resistors, inductors and the like that may be used to generate the desired structural and functional requirements of the design for the semiconductor substrate 1003. The first active devices may be formed using any suitable methods either within or else on the semiconductor substrate 1003.

Once the first active devices have been formed, the second through device vias 1007 and third metallization layers 1005 may be formed. In an embodiment the second through devices vias 1007 may be formed using similar processes and materials as the first through device vias 901, and the third metallization layers 1005 may be formed using similar processes and materials as the first metallization layers 501. However, any suitable processes and materials may be utilized.

Openings may be formed within the semiconductor substrate 1003 in order to receive first bridge dies 1004 and second bridge dies 1006, wherein the openings may be formed using, e.g., one or more photolithographic masking and etching processes. In an embodiment the first bridge dies 1004 may be local silicon interconnect (LSI) dies, which are used to bridge and electrically connect subsequently placed devices, and may be placed using, e.g., a pick and place process. In a particular embodiment the first bridge dies 1004 may comprise a second semiconductor substrate 1009 (similar to the semiconductor substrate 1003), third through substrate vias 1011 (similar to the first through device vias 901), and a fourth metallization layer 1013 (similar to the first metallization layer 501). However, any suitable structure and any suitable devices may be utilized.

In an embodiment the second bridge dies 1006 may also be local silicon interconnect (LSI) dies, but which are used to both optically and electrically connect subsequently placed devices, and may be placed using, e.g., a pick and place process. In a particular embodiment the second bridge dies 1006 may comprise a third semiconductor substrate 1015 (similar to the semiconductor substrate 1003), fourth through substrate vias 1017 (similar to the first through device vias 901), and a fifth metallization layer 1019 (similar to the first metallization layer 501).

However, in addition to the electrical connections provides by the fifth metallization layer 1019, the second bridge dies 1006 also comprise bridging optical components 1021 which are present along an upper surface of the fifth metallization layer 1019 in order to facilitate an optical connection between subsequently attached devices. In a particular embodiment the bridging optical components 1021 may be formed using similar processes and materials as the second optical components 503 (discussed above with respect to FIG. 5), such as by depositing a layer of silicon nitride or silicon and then patterning the layer into an optical device such as waveguides, couplers, etc. However, any suitable methods and materials may be used to from any suitable optical devices.

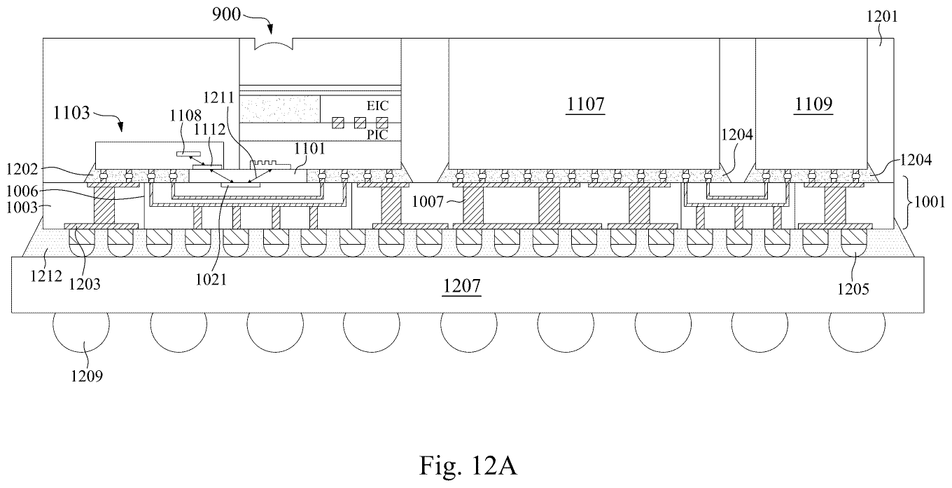

FIG. 11 illustrates a bonding of the first optical package 900 (in a simplified format for clarity) to the interposer substrate 1001. In an embodiment the bonding may be initiated by first placing and/or bonding a bonding film 1101 to the interposer substrate 1001 in order to provide additional structural support to the first optical package 900 while still allowing for the transmission of optical signals. In an embodiment the bonding film 1101 may be a one or more layers of a material such as silicon, silicon dioxide, silicon nitride, combinations of these, or the like, thick enough to be able to support the first optical package 900 after bonding. The bonding film 1101 may be attached to the interposer substrate 1001 using either a bonding process (e.g., a fusion bonding process) or else an adhesive may be used. Any suitable materials and methods may be utilized.

Once the bonding film 1101 has been placed, the first optical package 900 may be bonded to the interposer substrate 1001 using the bonding film 1101 as a physical support for the first optical package 900. In an embodiment the first optical package 900 may be attached to the interposer substrate 1001 by aligning the first external connectors 913 with conductive portions of the interposer substrate 1001 and by aligning optical components (e.g., a grating coupler) of the fourth optical components 803 with the bridging optical components 1021 of the second bridge dies 1006. Once aligned and in physical contact, the first external connectors 913 are reflowed by raising the temperature of the first external connectors 913 past a eutectic point of the first external connectors 913, thereby shifting the material of the first external connectors 913 to a liquid phase. Once reflowed, the temperature is reduced in order to shift the material of the first external connectors 913 back to a solid phase, thereby bonding the first optical package 900 to the interposer substrate 1001.

In some embodiments one or more of the first external connectors 913 is placed in contact with conductive portions of both the second bridging dies 1006 and the third metallization layers 1005. As such, the first optical package 900 may be electrically connected to both the second through device vias 1007 (for connection to devices through the interposer substrate 1001) and may also be electrically connected to other devices bonded to the same side of the interposer substrate 1001 as the first optical package 900. However, any suitable connections may be utilized.

FIG. 11 also illustrates a first optical die 1103 that is bonded to the interposer substrate 1001 and is in both electrical and optical connection with the first optical package 900 through one or more of the second bridge dies 1006. In one embodiment the first optical die 1103 may be a modulation die that is used to provide a modulation function or material that is isolated from the first optical package 900. In such an embodiment, the modulation die comprises a modulation substrate 1106, sixth optical components 1108 (which includes an overlying modulator), sixth metallization layers 1110, and seventh optical components 1112 (e.g., waveguides and/or couplers) within the sixth metallization layers 1110. In an embodiment the modulation substrate may be similar to the first substrate 101, such as by being a semiconductor material such as silicon or the like, the sixth optical components 1108 may be similar to the first optical components 203, and the sixth metallization layers 1110 and seventh optical components 1112 may be similar to the first metallization layers 501 and second optical components 503. However, any suitable components and materials may be utilized.

In some embodiments the sixth optical components 1108 comprise a modulator, such as a Mach-Zehnder modulator (MZM), used to receive optical signals from the first optical package 900 and modulate the optical signals before returning the optical signals to the first optical package 900 or other optical device. In such an embodiment in which the modulator is a Mach-Zehnder modulator, the modulator may comprise modulating units such as metal resistive heaters which comprise a metal material such as copper, aluminum, etc., which can be heated through, e.g., resistive heating as a current is run through the modulating units. Additionally, a first layer of the cladding material (e.g., a dielectric material) may be deposited, a first layer of core material (e.g., lithium niobate to form a thin film lithium niobate device) may be deposited and patterned as desired, and then another layer of the cladding material is deposited to cover the patterned core material. However, any suitable materials and processes may be utilized. However, any suitable materials, and any suitable modulator or combination of modulators, may be utilized.

In other embodiments, the first optical die 1103 may comprise other optical devices, either in addition to or else in lieu of the modulator described above. For example, in other embodiments, the first optical die 1103 may be a photodetector die which comprises one or more photodetectors. In particular embodiments the one or more photodetectors comprises semiconductor materials such as germanium or III-V materials such as GaAs, InGaAS that can be formed to receive an optical signal and translate the optical signal into an electrical signal. Any suitable optical devices, in any suitable combination, may be used, and all such devices and combinations are fully intended to be included within the scope of the embodiments.

Once the optical die 1103 has been formed, the first optical die 1103 may be bonded to the interposer substrate 1001 using, e.g., second external connectors 1105, which may be similar to the first external connectors 913 (e.g., solder balls). In some embodiments one or more of the second external connectors 1105 is placed in contact with conductive portions of both the second bridging dies 1006 and the third metallization layers 1005 and a reflow process is performed. As such, the first optical die 1103 may be electrically connected to both the second through device vias 1007 (for connection to devices through the interposer substrate 1001) and may also be electrically connected to other devices bonded to the same side of the interposer substrate 1001, such as the first optical package 900. However, any suitable connections may be utilized.

Additionally, in some embodiments, the alignment of the seventh optical components 1112 (e.g., a grating coupler) within the first optical die 1103 with the bridging optical components 1021 of the second bridge dies 1006 utilizes an open area where the second external connectors 1105 are not placed. As such, there is no structural support from the second external connectors 1105 in the region between the seventh optical components 1112 with the bridging optical components 1021 of the second bridge dies 1006. To help remedy this issue, the bonding film 1101 is used to help provide support for the first optical die 1103.

FIG. 11 additionally illustrates a bonding of a second semiconductor device 1107 and a third semiconductor device 1109 onto the interposer substrate 1001. In some embodiments, the second semiconductor device 1107 and the third semiconductor device 1109 are electronic integrated circuits (EIC) such as ASIC devices. In a particular embodiment the second semiconductor device 1107 and the third semiconductor device 1109 comprise an ASIC device and a high bandwidth memory device (similar to the HBM described above with respect to FIG. 6B). Of course, while the second semiconductor device 1107 and the third semiconductor device 1109 are ASIC and HBM devices in one embodiment, the embodiments are not restricted to the second semiconductor device 1107 and the third semiconductor device 1109 being ASIC and HBM devices. Rather, the second semiconductor device 1107 and the third semiconductor device 1109 may be any suitable semiconductor devices, such as a processor die, a memory die, or other type of functional die. In particular embodiments the second semiconductor device 1107 may be a logic die, a 3DIC die, a CPU, a GPU, a MEMS die, a XPU die, combinations of these, or the like. Any suitable device with any suitable functionality, may be used, and all such devices are fully intended to be included within the scope of the embodiments.

In an embodiment the second semiconductor device 1107 and the third semiconductor device 1109 may be bonded to the interposer substrate 1001 using, e.g., third external connections 1111. The third external connections 1111 may be conductive bumps (e.g., ball grid arrays, microbumps, etc.) or conductive pillars utilizing materials such as solder and copper. In an embodiment in which the third external connections 1111 are contact bumps, the third external connections 1111 may comprise a material such as tin, or other suitable materials, such as silver, lead-free tin, or copper. In an embodiment in which the third external connections 1111 are tin solder bumps, the third external connections 1111 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Additionally, once the third external connections 1111 have been placed, the second semiconductor device 1107 and the third semiconductor device 1109 are aligned with conductive portions of the interposer substrate 1001, such as the third metallization layers 1005 and/or the first bridging dies 1004. Once aligned and in physical contact, the third external connections 1111 are reflowed by raising the temperature of the third external connections 1111 past a eutectic point of the third external connections 1111, thereby shifting the material of the third external connections 1111 to a liquid phase. Once reflowed, the temperature is reduced in order to shift the material of the third external connections 1111 back to a solid phase, thereby bonding the second semiconductor device 1107 and the third semiconductor device 1109 to the interposer substrate 1001.

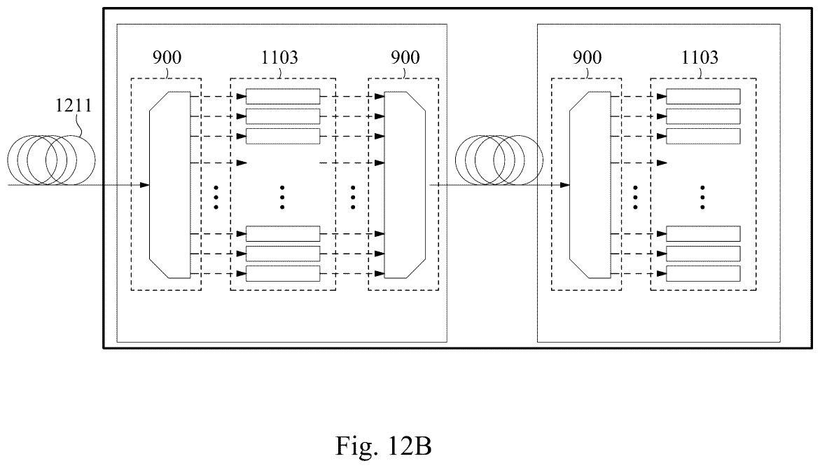

FIG. 12A illustrates that, once the first optical die 1103, the second semiconductor device 1107, the third semiconductor device 1109, and the first optical package 900 have been bonded to the interposer substrate 1001, a first underfill 1202 and a second underfill 1204 may be placed between the interposer substrate 1001 and overlying devices. The first underfill 1202 and the second underfill 1204 may reduce stress and protect the joints resulting from the reflowing of the first external connectors 913, the second external connectors 1105, and the third external connections 1111. The first underfill 1202 and the second underfill 1204 may be formed by capillary flow processes after the first optical package 900, the first optical die 1103, the second semiconductor device 1107 and the third semiconductor device 1109 have been attached.

Once the first underfill 1202 and the second underfill 1204 have been placed, the first optical die 1103, the second semiconductor device 1107, the third semiconductor device 1109, and the first optical package 900 are encapsulated with an encapsulant 1201. In an embodiment the encapsulant 1201 may be a material such as a molding compound placed using an injection molding process. Once in place, the molding compound may be cured. However, any suitable material and process may be used.

FIG. 12A illustrates that, once the encapsulant 1201 has been placed and cured, the encapsulant 1201 may be planarized. In an embodiment the encapsulant 1201 may be planarized using a planarization process such as a chemical mechanical polishing process until the encapsulant 1201 is planar with one or both of the second semiconductor device 1107 and the third semiconductor device 1109. However, any suitable planarization process may be utilized.

Once the encapsulant 1201 has been placed and thinned, the semiconductor substrate 1003 may be thinned until the second TDVs 1007 have been exposed. In an embodiment the semiconductor substrate 1003 may be thinned using, e.g., a chemical mechanical polishing process, a grinding process, or the like. Further, once exposed, the second TDVs 1007 may be recessed using, e.g., one or more etching processes, such as a wet etch process in order to recess the semiconductor substrate 1003 so that the second TDVs 1007 extend out of the semiconductor substrate 1003.

Once the second TDVs 1007 have been formed, a seventh metallization layer 1203 may be formed on an opposite side of the semiconductor substrate 1003 from the third metallization layers 1005. The seventh metallization layer 1203 may be formed using similar methods and materials as the third metallization layers 1005. However, any suitable methods may be utilized.

Fourth external connectors 1205 may be placed on the seventh metallization layer 1203 and may be, e.g., a ball grid array (BGA) which comprises a eutectic material such as solder, although any suitable materials may be used. Optionally, an underbump metallization or additional metallization layers may be utilized between the seventh metallization layers 1203 and the fourth external connectors 1205. In an embodiment in which the fourth external connectors 1205 are solder bumps, the fourth external connectors 1205 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the fourth external connectors 1205 have been formed, a test may be performed to ensure that the structure is suitable for further processing.

Of course, while the above described process in one method by which the interposer substrate 1001 may be formed, this description is intended to be illustrative and is not intended to limit the embodiments. Rather, any suitable method of forming the interposer substrate 1001 may be utilized. For example, in another embodiment, the second TDVs 1007 may be formed first and the first bridge dies 1004 may be placed and then encapsulated with an encapsulant (instead of being placed within the semiconductor substrate 1003), and then the metallization layers may be formed. Any suitable process and devices may be utilized and all such processes are fully intended to be included within the scope of the embodiments.

FIG. 12A also illustrates that, once the fourth external connectors 1205 have been formed, the interposer substrate 1001 may be bonded to a second substrate 1207 with, e.g., the fourth external connectors 1205. In an embodiment the second substrate 1207 may be a package substrate, which may be a printed circuit board (PCB) or the like. The second substrate 1207 may include one or more dielectric layers and electrically conductive features, such as conductive lines and vias. In some embodiments, the second substrate 1207 may include through-vias, active devices, passive devices, and the like. The second substrate 1207 may further include conductive pads formed at the upper and lower surfaces of the second substrate 1207.

The fourth external connectors 1205 may be aligned with corresponding conductive connections on the second substrate 1207. Once aligned the fourth external connectors 1205 may then be reflowed in order to bond the second substrate 1207 to the interposer substrate 1001. However, any suitable bonding process may be used to connect the interposer substrate 1001 to the second substrate 1207.

Once bonded a third underfill 1212 may be placed around the fourth external connectors 1205. The third underfill 1212 may be formed by capillary flow processes after the first interposer 1001 has been attached to the second substrate 1207.

Additionally, the second substrate 1207 may be prepared for further connections by placing fifth external connections 1209 on an opposite side of the second substrate 1207 from the interposer substrate 1001. In an embodiment the fifth external connections 1209 may be formed using similar processes and materials as the fourth external connectors 1205. However, any suitable materials and processes may be utilized.

In operation, the first optical package 900 will receive and/or generate optical signals (represented in FIG. 12A by the arrows labeled 1211). These optical signals 1211 will be transmitted from the first optical package 900 (using, e.g., a grating coupler) to the bridging optical components 1021, and the bridging optical components 1021 (e.g., waveguide) then transmit the optical signals 1211 to a region under the first optical die 1103. Once there, the optical signals 1211 will be transmitted to the seventh optical components 1112 of the first optical die 1103, and then to the modulator within the sixth optical components 1108. The modulator within the sixth optical components 1108 then modulates the optical signals 1211 and can either then either return the modulated optical signals 1211 to the first optical package 900 or to another optical device.

FIG. 12B illustrates a simplified view of the transmission of the optical signals 1211 (from, e.g., an optical fiber - not separately illustrated) to the first optical package 900, which demultiplexes the optical signals 1211 and then sends the optical signals 1211 to the first optical die 1103 through, e.g., the second bridge dies 1006 (not seen in this figure). The first optical die 1103 receives the optical signals 1211 and modulates the optical signals 1211 using, e.g., the sixth optical components 1108 (e.g., a modulator). The optical signals 1211 are then routed back to the first optical package 900, where the optical signals are multiplexed and transmitted to another device, such as another first optical package 900. The another first optical package 900 then receives the optical signals 1211, demultiplexes the optical signals 1211, and routes the optical signals 1211 to another one of the first optical dies 1103 through, e.g., another second bridge dies 1006 (also not seen in this figure). The another one of the first optical dies 1103 can then receive the optical signals 1211 and transforms the optical signals 1211 into electrical signals using, e.g., photodetectors. However, any suitable combination of devices may be utilized.

By utilizing the interposer substrate 1001 as an optical substrate as well as an electrical substrate, die-to-die optical signal transition can be achieved in an optical-on-interposer structure. As such, third party modulators and photodetectors can be achieved in a CoWoS device, thereby realizing high-speed modulation and photodetectors while still having a high compatibility with manufacturing flows. All of this allows for an increase in the overall data rate of the device.

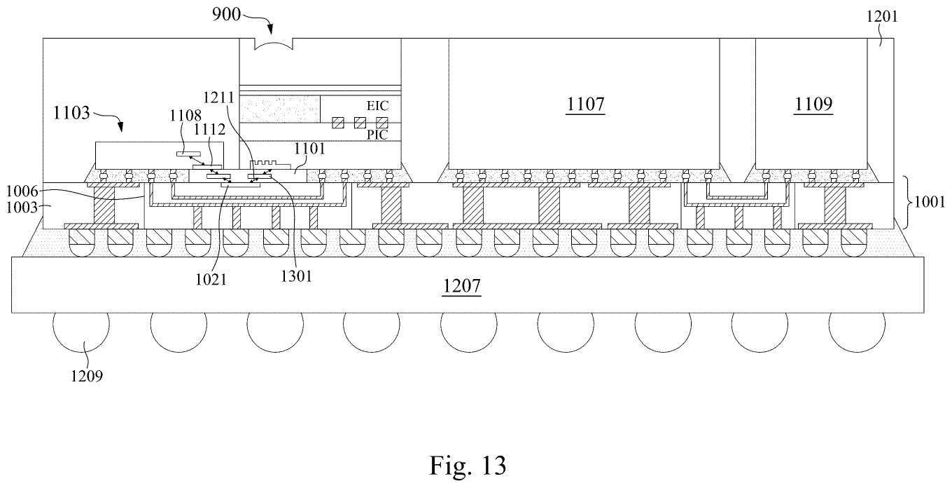

FIG. 13 illustrates another embodiment in which the first optical package 900 is electrically and optically connected to the first optical die 1103 through the second bridging dies 1006. In this embodiment, however, the bonding film 1101 comprises eighth optical components 1301 such as one or more waveguides or other optical components. In an embodiment the eighth optical components 1301 may be formed using similar materials and processes as either the first optical components 203 (described above with respect to FIG. 2) and the second optical components 503 (described above with respect to FIG. 5). However, any suitable processes and materials may be utilized.

In operation in this embodiment, the first optical package 900 will receive and/or generate the optical signals 1211. These optical signals 1211 will be transmitted from the first optical package 900 (using, e.g., a grating coupler) to the eighth optical components 1301 of the bonding film 1101 and then to the bridging optical components 1021 of the second bridging dies 1006. The bridging optical components 1021 (e.g., waveguides) then transmit the optical signals 1211 to a region under the first optical die 1103. Once there, the optical signals 1211 will be transmitted back to different eighth optical components 1301 within the bonding film 1101 before being sent to the seventh optical components 1112 of the first optical die 1103, and then to the modulator within the sixth optical components 1108. The modulator within the sixth optical components 1108 then modulates the optical signals 1211 and can either then either return the modulated optical signals 1211 to the first optical package 900 or to another optical device.

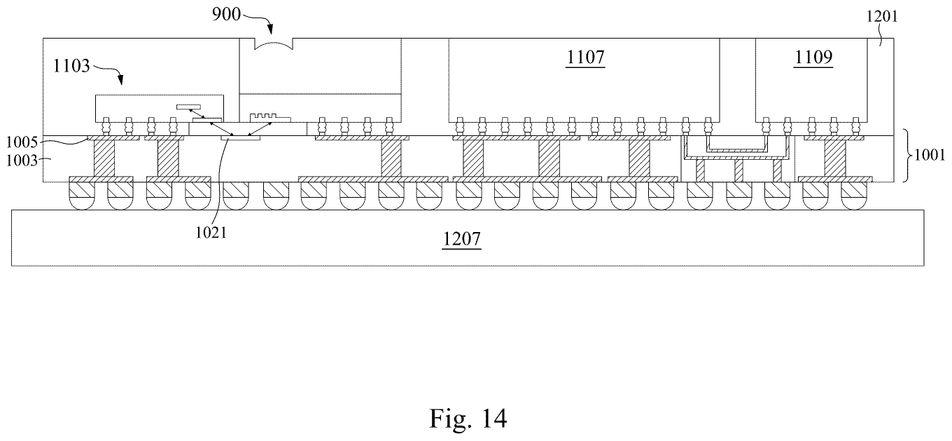

FIG. 14 illustrates yet another embodiment in which the first optical package 900 is electrically and optically connected to the first optical die 1103. In this embodiment, however, the interposer substrate 1001 is formed without the second bridging die 1006 and, consequently, without the bridging optical components 1021 formed within the second bridging die 1006. Rather, in this embodiment the bridging optical components 1021 are formed directly on the semiconductor substrate 1003 within the third metallization layers 1005.

In this embodiment the bridging optical components 1021 within the third metallization layers 1005 may be formed using materials that are at least in part based on the material of the semiconductor substrate 1003. For example, when the semiconductor substrate 1003 comprises silicon, the bridging optical components 1021 may be formed of silicon or silicon nitride. In another embodiment, when the semiconductor substrate 1003 comprises an organic material, the bridging optical components 1021 includes an organic material. In yet another embodiment, when the semiconductor substrate 1003 comprises glass, the bridging optical components 1021 may comprise glass.

In an embodiment the bridging optical components 1021 can be formed using similar processes as the second optical components 503 within the first metallization layers 501 (described above with respect to FIG. 5). For example, a core material may be deposited and then patterned into the desired shape for the bridging optical components 1021, such as the desired waveguides, and then a remainder of the first metallization layers 501 may be formed around the bridging optical components 1021. However, any suitable methods and materials may be formed.

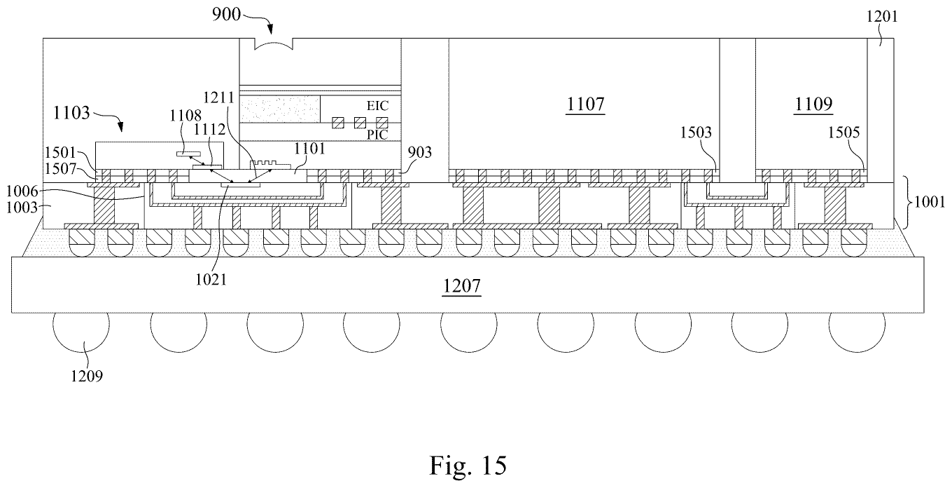

FIG. 15 illustrates yet another embodiment in which the first optical package 900 is optically and electrically connected to the first optical die 1103 through the second bridging dies 1006. In this embodiment, however, the first optical package 900, the first optical die 1103, the second semiconductor device 1107 and the third semiconductor device 1109 are bonded to the interposer substrate 1001 using a metal-to-metal and dielectric-to-dielectric bonding process. In such an embodiment the third bonding layer 903 is formed without the first external connectors 913, a third bonding layer 1501 is formed on the first optical die 1103, a fourth bonding layer 1503 is formed on the second semiconductor device 1107, a fifth bonding layer 1505 is formed on the third semiconductor device 1109, and a sixth bonding layer 1507 (with multiple sections) is formed on the interposer substrate 1001. In an embodiment the third bonding layer 1501, the fourth bonding layer 1503, the fifth bonding layer 1505, and the sixth bonding layer 1507 may be formed using similar processes and materials as the first bonding layer 505 (described above with respect to FIG. 5). However, any suitable methods and materials may be utilized.

Once the third bonding layer 1501, the fourth bonding layer 1503, the fifth bonding layer 1505, and the sixth bonding layer 1507 have been formed, the third bonding layer 1501, the fourth bonding layer 1503, and the fifth bonding layer 1505 are bonded to the sixth bonding layer 1507 using, e.g., a metal-to-metal and dielectric-to-dielectric bonding process. In an embodiment the metal-to-metal and dielectric-to-dielectric bonding process may be performed as described above with respect to FIG. 6A. However, any suitable bonding processes may be performed.

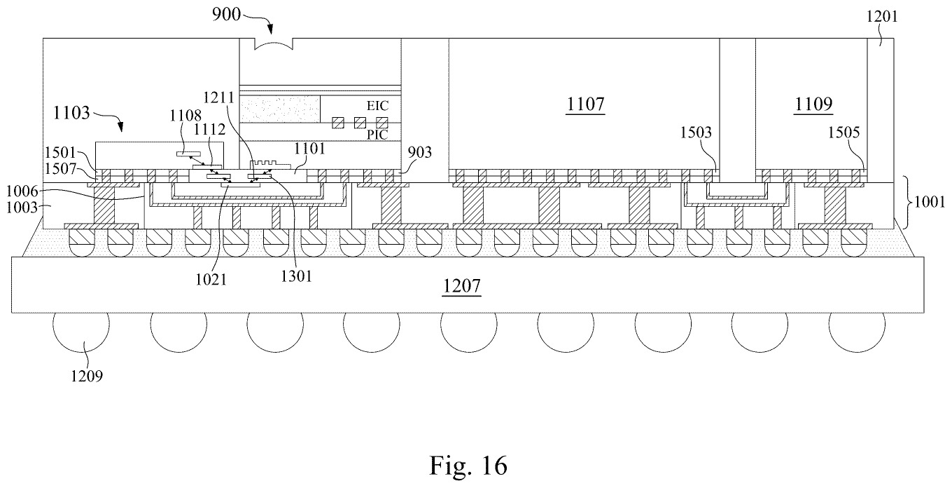

FIG. 16 illustrates yet another embodiment in which the third bonding layer 1501, the fourth bonding layer 1503, the fifth bonding layer 1505, and the sixth bonding layer 1507 have been formed, and the third bonding layer 1501, the fourth bonding layer 1503, and the fifth bonding layer 1505 are bonded to the sixth bonding layer 1507 using, e.g., a metal-to-metal and dielectric-to-dielectric bonding process. In this embodiment, however, the bonding film 1101 comprises the eighth optical components 1301 such as waveguides in order to receive and transmit the optical signals 1211 between the first optical package 900, the second bridging die 1006, and the first optical die 1103.

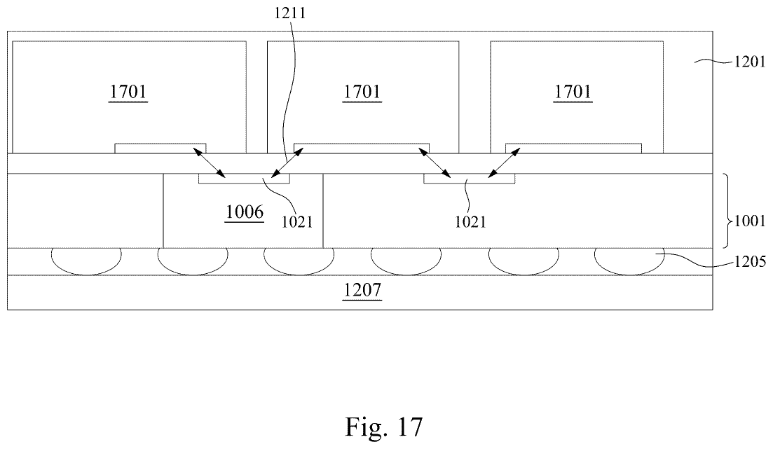

FIG. 17 illustrates a simplified version of the various optical interconnections that can occur using the above described embodiments wherein there are no electrically connections between the interposer substrate 1001 and the overlying devices. In particular, various optical devices 1701 (which may be any of the first optical package 900 or the first optical die 1103 using either a modulator or a photodetector) are fusion bonded (e.g., dielectric-to-dielectric bonding) to the interposer substrate 1001 and are interconnected optically using either the bridging optical components 1021 located within the second bridging die 1006 or else the bridging optical components 1021 without the second bridging die 1006. However, any suitable combination of connections may be utilized.

By utilizing the interposer substrate 1001 as an optical substrate as well as an electrical substrate, die-to-die optical signal transition can be achieved in an optical-on-interposer structure. As such, third party modulators and photodetectors can be achieved in a CoWoS device, thereby realizing high-speed modulation and photodetectors while still having a high compatibility with manufacturing flows. All of this allows for an increase in the overall data rate of the device.

In some embodiments, a method of forming an optical device includes: forming an optical interposer, the forming the optical interposer including: receiving a first substrate; forming an opening in the first substrate; and placing a bridge die into the opening in the first substrate, the bridge die including at least one waveguide; bonding a first package to the optical interposer over a first portion of the bridge die; and bonding a die to the optical interposer over a second portion of the bridge die, the die comprising at least one waveguide. In an embodiment the method further includes placing a bonding film over the bridge die prior to the bonding the first package. In an embodiment the bonding film comprises a waveguide. In an embodiment the die comprises an optical modulator. In an embodiment the die comprises a photodetector. In an embodiment the bonding the first package comprises reflowing a solder material. In an embodiment the bonding the first package comprises performing a dielectric-to-dielectric and metal-to-metal bonding process.

In another embodiment, a method of forming an optical device includes: forming an opening in an interposer substrate; placing a first waveguide within the interposer substrate; bonding a first optical device in optical and electrical connection with the interposer substrate; bonding a second optical device in optical connection with the first optical device through the first waveguide; and sending an optical signal from the first optical device to the second optical device through the first waveguide. In an embodiment the first waveguide is within a first bridging die. In an embodiment the bonding the first optical device comprises performing a dielectric-to-dielectric and metal-to-metal bond. In an embodiment the bonding the first optical device comprises performing a reflow process. In an embodiment the method further includes placing a bonding film onto the interposer substrate prior to the bonding the first optical device. In an embodiment the bonding film comprises a waveguide. In an embodiment the method further includes forming a second waveguide within a metallization layer of the interposer substrate.

In another embodiment, an optical device includes: an optical interposer including: a first substrate; and an optical bridge die embedded within the first substrate, the optical bridge die including a first waveguide; a first package bonded to the optical interposer over a first portion of the optical bridge die, the first package including a second waveguide; and a die bonded to the optical interposer over a second portion of the optical bridge die, the die including a third waveguide. In an embodiment the optical device further includes a bonding film located between the first package and the optical bridge die. In an embodiment the bonding film comprises a waveguide. In an embodiment the die comprises an optical modulator. In an embodiment the die comprises a photodetector. In an embodiment the optical device further includes a high bandwidth memory bonded to the optical interposer 1001, the high bandwidth memory comprising a die stack.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of forming an optical device, the method comprising:
forming an optical interposer, the forming the optical interposer comprising:
receiving a first substrate;
forming an opening in the first substrate; and
placing a bridge die into the opening in the first substrate, the bridge die comprising at least one waveguide;
bonding a first package to the optical interposer over a first portion of the bridge die; and
bonding a die to the optical interposer over a second portion of the bridge die, the die comprising at least one waveguide.

2. The method of claim 1, further comprising placing a bonding film over the bridge die prior to the bonding the first package.

3. The method of claim 2, wherein the bonding film comprises a waveguide.

4. The method of claim 1, wherein the die comprises an optical modulator.

5. The method of claim 1, wherein the die comprises a photodetector.

6. The method of claim 1, wherein the bonding the first package comprises reflowing a solder material.

7. The method of claim 1, wherein the bonding the first package comprises performing a dielectric-to-dielectric and metal-to-metal bonding process.

8. A method of forming an optical device, the method comprising:
forming an opening in an interposer substrate;
placing a first waveguide within the interposer substrate;
bonding a first optical device in optical and electrical connection with the interposer substrate;
bonding a second optical device in optical connection with the first optical device through the first waveguide; and
sending an optical signal from the first optical device to the second optical device through the first waveguide.

9. The method of claim 8, wherein the first waveguide is within a first bridging die.

10. The method of claim 8, wherein the bonding the first optical device comprises performing a dielectric-to-dielectric and metal-to-metal bond.

11. The method of claim 8, wherein the bonding the first optical device comprises performing a reflow process.

12. The method of claim 8, further comprising placing a bonding film onto the interposer substrate prior to the bonding the first optical device.

13. The method of claim 12, wherein the bonding film comprises a waveguide.

14. The method of claim 8, further comprising forming a second waveguide within a metallization layer of the interposer substrate.

15. An optical device comprising:
an optical interposer comprising:
a first substrate; and
an optical bridge die embedded within the first substrate, the optical bridge die comprising a first waveguide;
a first package bonded to the optical interposer over a first portion of the optical bridge die, the first package comprising a second waveguide;
and a die bonded to the optical interposer over a second portion of the optical bridge die, the die comprising a third waveguide.

16. The optical device of claim 15, further comprising a bonding film located between the first package and the optical bridge die.

17. The optical device of claim 16, wherein the bonding film comprises a waveguide.

18. The optical device of claim 15, wherein the die comprises an optical modulator.

19. The optical device of claim 15, wherein the die comprises a photodetector.

20. The optical device of claim 15, further comprising a high bandwidth memory bonded to the optical interposer 1001, the high bandwidth memory comprising a die stack.
